(19) United States
(12) Patent Application Publication
(10) Pub. No.: US 2008/0290037 A1
(43) Pub. Date: Nov. 27, 2008

(54) Methods and Apparatuses for Separating Biological Particles

(75) Inventor: Yingjie Liu, Foster City, CA (US)

Correspondence Address: MILA KASAN, PATENT DEPT.;APPLIED BIOSYSTEMS, 850 LINCOLN CENTRE DRIVE, FOSTER CITY, CA, 94404, US

(73) Assignee: Applera Corporation, Foster City, CA (US)

(21) Appl. No.: 11/752,502

(22) Filed: May 23, 2007

(51) Int. Cl. B01D 35/06; B01D 35/30; B03C 1/01; B03D 1/00

(52) U.S. Cl. 210/695; 210/103; 210/115; 210/209; 210/223; 210/703; 210/767; 210/93; 210/97

(57) ABSTRACT

Methods and apparatuses for separating biological particles are provided.

### FIELD

Methods and apparatuses for separating biological particles are provided.

### BACKGROUND

In order to carry out forensic DNA analysis on sexual assault evidence, sperm DNA derived from the perpetrator often must be separated from epithelial DNA derived from the victim. To achieve that separation, some methods involve separating the sperm cells from the epithelial cells, and then extracting the DNA from the separated cell fractions. In certain instances, a mixture of sperm and epithelial cells is filtered through an 8 μm Nylon mesh filter in order to achieve separation of the sperm and epithelial cells. Sperm cells theoretically will pass through the mesh, while epithelial cells cannot. One drawback of such a method, however, is that epithelial cells clog the mesh over time, reducing the efficiency of separation. Recovery of sperm cells can be increased by using the Nylon mesh and centrifugation, but clogging can still be a problem.

In another instance, Eisenberg addressed the separation of sperm and epithelial cells through the development of antibody-based separation schemes using magnetic beads with covalently bound sperm-specific antibodies to selectively retain the sperm heads. There are potential problems associated with this approach, most notably clogging of the separation column by the large numbers of epithelial cells in casework samples. In addition to clogging, drawbacks of this technique include the cost of the materials required for the antibody/bead separation method, combined with the numerous steps required to yield PCR-ready DNA (Eisenberg, A. Development of a Spermatozoa Capture System for the Differential Extraction of Sexual Assault Evidence; Presented at Profiling PCR and Beyond, Washington, D.C., Jun. 28, 2002.).

In another instance, Elliott et al. reported selective capture of sperm cells from slides using laser capture microdissection. This method is time-consuming, labor-intensive (to identify the sperm cells in the sample), and not likely to be amenable to high-throughput applications (Elliott, K.; Hill, D. S.; Lambert, C.; Burroughes, T. R.; Gill, P. Forensic Sci. Int. 2003, 137, 28-36.).

In another instance, Schoell et al. demonstrated a fluorescence-activated cell sorting method for the separation of sperm and vaginal cells. However, the authors indicate that the use of this method would require altering the collection of evidentiary samples from vaginal swabs to vaginal lavages (Schoell, W. M.; Klintschar, M.; Mirhashemi, R.; Pertl, B. Obstet. Gynecol. (NY) 1999, 94, 623-627.).

In another instance, Horsman et al. demonstrated separation of sperm cells from epithelial cells on a microfluidic device. This separation utilizes the differential physical properties of the cells that results in settling of the epithelial cells to the bottom of the inlet reservoir and subsequent adherence to the glass substrate. As a result, low flow rates can be used to separate the sperm cells from the epithelial cell-containing biological mixture (Horsman, K. M., Barker, S. L. R., Ferrance, J. P., Forrest, K. A, Koen, K. A., and Landers, J. P. Anal. Chem. 2005, 77, 742-749).

### SUMMARY

In certain embodiments, a method of separating first biological particles from second biological particles is provided. In certain embodiments, a mixture comprising one or more first biological particles and one or more second biological particles is provided. In certain embodiments, at least a portion of the mixture and a first liquid are flowed into a first inlet port of a separation apparatus. In certain embodiments, the separation apparatus comprises the first inlet port, a second inlet port, and a separation region. In certain embodiments, the first inlet port and the second inlet port are operably connected to a first end of the separation region. In certain embodiments, the separation region comprises two or more posts aligned along a plane extending along a diagonal axis from the first end of the separation region to a second end of the separation region. In certain embodiments, the spacing between adjacent posts is such that a first biological particle can pass between the posts but a second biological particle cannot pass between the posts. In certain embodiments, a second liquid is flowed into the second inlet port. In certain embodiments, the flow rate of the first liquid and the flow rate of the second liquid are such that when the mixture enters the separation region, substantially all of the one or more first biological particles pass between the two or more posts to a second lateral side of the separation region, and substantially all of the one or more second biological particles remain on a first lateral side of the separation region.

In certain embodiments, a method of separating first biological particles from second biological particles is provided. In certain embodiments, a mixture comprising one or more first biological particles and one or more second biological particles is provided. In certain embodiments, at least a portion of the mixture and a first liquid are flowed into a first inlet port of a separation apparatus. In certain embodiments, the separation apparatus comprises the first inlet port, a second inlet port, a third inlet port, and a separation region. In certain embodiments, the first inlet port, the second inlet port, and the third inlet port are operably connected to a first end of the separation region. In certain embodiments, the separation region comprises two or more posts aligned along a plane extending along a diagonal axis from the first end of the separation region to a second end of the separation region. In certain embodiments, the spacing between adjacent posts is such that a first biological particle can pass between the posts but a second biological particle cannot pass between the posts. In certain embodiments, a second liquid is flowed into the second inlet port and a third liquid into the third inlet port. In certain embodiments, the flow rate of the first liquid, the flow rate of the second liquid, and the flow rate of the third liquid are such that when the mixture enters the separation region, substantially all of the one or more first biological particles pass between the two or more posts to a second lateral side of the separation region, and substantially all of the one or more second biological particles remain on a first lateral side of the separation region.

In certain embodiments, a method of separating first biological particles from second biological particles is provided. In certain embodiments, a mixture comprising one or more first biological particles and one or more second biological particles is provided. In certain embodiments, at least a portion of the mixture and a first liquid are flowed into a first inlet port of a separation apparatus. In certain embodiments, the separation apparatus comprises the first inlet port, a second inlet port, and a separation region. In certain embodiments, the first inlet port and the second inlet port are operably connected to a first end of the separation region. In certain embodiments, the separation region comprises two or more posts that are structurally arranged to permit the one or more first biological particles to move to a first location in the separation region while preventing the one or more second biological particles from moving to the first location of the separation region. In certain embodiments, a second liquid is flowed into the second inlet port. In certain embodiments, the flow rate of the first liquid and the flow rate of the second liquid are such that when the mixture enters the separation region, substantially all of the one or more first biological particles move to the first location in the separation region.

In certain embodiments, an apparatus for separating first biological particles from second biological particles is provided. In certain embodiments, the apparatus comprises, (a) a separation region; b) a first inlet port operably connected to a first end of the separation region; c) a second inlet port operably connected to the first end of the separation region; d) two or more posts aligned along a plane extending along a diagonal axis from the first end of the separation region to a second end of the separation region. In certain embodiments, the spacing between adjacent posts is such that a first biological particle can pass between the posts but a second biological particle cannot pass between the posts.

In certain embodiments, a method of separating sperm cells from epithelial cells is provided. In certain embodiments, a mixture comprising one or more sperm cells and one or more epithelial cells is provided. In certain embodiments, at least a portion of the mixture and a first liquid are flowed into a first inlet port of a separation apparatus. In certain embodiments, the separation apparatus comprises the first inlet port, a second inlet port, a pinched region, and a broadened region. In certain embodiments, the first inlet port and the second inlet port are operably connected to a first end of the pinched region. In certain embodiments, a second end of the pinched region is operably connected to a first end of the broadened region. In certain embodiments, a second liquid is flowed into the second inlet port. In certain embodiments, the flow rate of the first liquid and the flow rate of the second liquid are such that when the mixture enters the pinched region, substantially all of the cells become aligned against a first wall of the pinched region. In certain embodiments, the flow of the first liquid and the second liquid is continued such that when the mixture enters and passes through the broadened region, the one or more sperm cells and the one or more epithelial cells become separated.

In certain embodiments, a method of separating sperm cells from epithelial cells is provided. In certain embodiments, a mixture comprising one or more sperm cells and one or more epithelial cells is provided. In certain embodiments, the one or more sperm cells in the mixture is attached to one or more microparticles. In certain embodiments, the microparticles (i) increase the density of the sperm cells, or (ii) are paramagnetic. In certain embodiments, at least a portion of the mixture and a first liquid is flowed into a first inlet port of a separation apparatus. In certain embodiments, the separation apparatus comprises the first inlet port, a second inlet port, a separation region, a first outlet port, and a second outlet port. In certain embodiments, the first inlet port and the second inlet port are operably connected to a first end of the separation region. In certain embodiments, the first outlet port and the second outlet port are operably connected to a second end of the separation region. In certain embodiments, a second liquid is flowed into the second inlet port. In certain embodiments, a force is exerted on the separation region. In certain embodiments, the force is selected from gravitational force and magnetic force, such that the one or more sperm cells attached to one or more microparticles move to a second location in the separation region, while the one or more epithelial cells remain in a first location of the separation region. In certain embodiments, the flow of the first liquid and the second liquid is continued such that one or more sperm cells enter the second outlet port and the one or more epithelial cells enter the first outlet port.

In certain embodiments, a method of separating sperm cells from epithelial cells is provided. In certain embodiments, a mixture comprising one or more sperm cells and one or more epithelial cells is provided. In certain embodiments, at least a portion of the mixture and a first liquid is flowed into an inlet port of a separation apparatus. In certain embodiments, the separation apparatus comprises the inlet port, a separation region, and at least two outlet ports. In certain embodiments, the inlet port is operably connected to a first end of the separation region. In certain embodiments, the at least two outlet ports are operably connected to a second end of the separation region. In certain embodiments, the separation region comprises an array of obstacles. In certain embodiments, a second liquid is flowed into the inlet port, such that the first and second biological particles continue to flow through the separation region. In certain embodiments, the sperm cells and the epithelial cells travel along different paths in the separation region. In certain embodiments, the flow of the second liquid is continued such that at least a portion of the sperm cells flow into a first outlet port and at least a portion of the epithelial cells flow into a second outlet port.

In certain embodiments, a method of separating blood cells is provided. In certain embodiments, a mixture comprising one or more first blood cells and one or more second blood cells is provided. In certain embodiments, at least a portion of the mixture and a first liquid is flowed into a first inlet port of a separation apparatus. In certain embodiments, the separation apparatus comprises the first inlet port, a second inlet port, a pinched region, and a broadened region. In certain embodiments, the first inlet port and the second inlet port are operably connected to a first end of the pinched region. In certain embodiments, a second end of the pinched region is operably connected to a first end of the broadened region. In certain embodiments, a second liquid is flowed into the second inlet port. In certain embodiments, the flow rate of the first liquid and the flow rate of the second liquid are such that when the mixture enters the pinched region, substantially all of the blood cells become aligned against a first wall of the pinched region. In certain embodiments, the flow of the first liquid and the second liquid is continued such that when the mixture enters and passes through the broadened region, the one or more first blood cells and the one or more second blood cells become separated.

In certain embodiments, a method of separating blood cells is provided. In certain embodiments, a mixture comprising one or more first blood cells and one or more second blood cells is provided. In certain embodiments, the one or more first blood cells in the mixture is attached to one or more microparticles. In certain embodiments, the microparticles (i) increase the density of the first blood cells, or (ii) are paramagnetic. In certain embodiments, at least a portion of the mixture and a first liquid are flowed into a first inlet port of a separation apparatus. In certain embodiments, the separation apparatus comprises the first inlet port, a second inlet port, a separation region, a first outlet port, and a second outlet port. In certain embodiments, the first inlet port and the second inlet port are operably connected to a first end of the separation region. In certain embodiments, the first outlet port and the second outlet port are operably connected to a second end of the separation region. In certain embodiments, a second liquid is flowed into the second inlet port. In certain embodiments, a force is exerted on the separation region. In certain embodiments, the force is selected from gravitational force and magnetic force, such that the one or more first blood cells attached to one or more microparticles move to a second location in the separation region, while the one or more second blood cells remain in a first location of the separation region. In certain embodiments, the flow of the first liquid and the second liquid is continued such that one or more first blood cells enter the second outlet port and the one or more second blood cells enter the first outlet port.

In certain embodiments, a method of separating first blood cells from second blood cells is provided. In certain embodiments, a mixture comprising one or more first blood cells and one or more second blood cells is provided. In certain embodiments, at least a portion of the mixture and a first liquid is flowed into an inlet port of a separation apparatus. In certain embodiments, the separation apparatus comprises the inlet port, a separation region, and at least two outlet ports. In certain embodiments, the inlet port is operably connected to a first end of the separation region. In certain embodiments, the at least two outlet ports are operably connected to a second end of the separation region. In certain embodiments, the separation region comprises an array of obstacles. In certain embodiments, a second liquid is flowed into the inlet port, such that the first and second blood cells continue to flow through the separation region. In certain embodiments, the first blood cells and the second blood cells travel along different paths in the separation region. In certain embodiments, the flow of the second liquid is continued such that at least a portion of the first blood cells flow into a first outlet port and at least a portion of the second blood cells flow into a second outlet port.

These and other features of the present teachings are set forth herein.

### BRIEF DESCRIPTION OF THE FIGURES

FIG. 1 shows a non-limiting exemplary pinched flow fractionation apparatus.

FIGS. 2A through 2G show certain non-limiting exemplary pinched flow fractionation apparatuses. The pinched flow apparatus shown in FIG. 2A includes a pinch channel with a width of 90 μm and length of 200 μm. The width of the broadened channel of the pinched flow apparatus in FIG. 2A is 1000 μm. The pinched flow apparatus shown in FIG. 2B includes a pinch channel with a width of 150 μm and length of 400 μm. The width of the broadened channel of the pinched flow apparatus in FIG. 2B is 1000 μm. The pinched flow apparatus shown in FIG. 2C includes a pinch channel with a width of 90 μm and length of 200 μm. The width of the broadened channel of the pinched flow apparatus in FIG. 2C is 1000 μm. The pinched flow apparatus shown in FIG. 2D includes a pinch channel with a width of 90 μm and length of 400 μm. The width of the broadened channel of the pinched flow apparatus in FIG. 2D is 1000 μm. The pinched flow apparatus shown in FIG. 2E includes a pinch channel with a width of 150 μm and length of 200 μm. The width of the broadened channel of the pinched flow apparatus in FIG. 2E is 1000 μm. The pinched flow apparatus shown in FIG. 2F includes a pinch channel with a width of 150 μm and length of 400 μm. The width of the broadened channel of the pinched flow apparatus in FIG. 2F is 1000 μm. The pinched flow apparatus shown in FIG. 2G includes a pinch channel with a width of 150 μm and length of 400 μm. The width of the broadened channel is 1500 μm.

FIG. 3 shows a non-limiting exemplary pinched flow fractionation apparatus. All units in FIG. 3 are in mm.

FIG. 4 shows a non-limiting exemplary pinched flow fractionation apparatus comprising collection channels. In the exemplary apparatus depicted in FIG. 4, outlet channel 1 is used to collect a first biological particle, e.g., sperm cells, and outlet 2 is used to collect a second biological particle, e.g., epithelial cells. Outlet channels 3, 4, and 5 are used to balance the flow and are not used to collect cells.

FIG. 5 shows a non-limiting exemplary split-flow thin fractionation apparatus. Outlet a and Outlet b are both potential detection regions in the apparatus.

FIG. 6A shows the separation region of a non-limiting exemplary asymmetric laminar flow apparatus. FIG. 6B shows a non-limiting exemplary asymmetric laminar flow apparatus featuring two fluid inlets, a sample inlet, a separation region, four outlets, and four detection regions.

FIG. 7 shows a non-limiting exemplary separation apparatus comprising posts.

FIG. 8 shows a non-limiting exemplary separation apparatus comprising elongated posts.

FIGS. 9A through 9C show certain non-limiting exemplary separation apparatuses comprising posts.

FIGS. 10A through 10C show three views of a non-limiting exemplary separation apparatus comprising elongated posts. All units in FIG. 10 are in mm. FIG. 10A shows the apparatus, including the separation region, two inlet ports, and two outlet ports. FIGS. 10B and 10C show expanded views of the separation region. The length of the posts is 0.150 mm and the width of the channel is 0.400 mm.

FIGS. 11A and 11B show two views of a non-limiting exemplary separation apparatus comprising elongated posts. FIG. 11A shows the apparatus, including the separation region, three inlet ports, and two outlet ports. FIG. 11B shows an expanded view of the separation region.

FIG. 12 shows a non-limiting exemplary separation apparatus comprising elongated posts comprising three different separations regions to separate biological particles into four separate detecting regions based on the size of the particles.

### DETAILED DESCRIPTION OF CERTAIN EMBODIMENTS

The section headings used herein are for organizational purposes only and are not to be construed as limiting the subject matter described. All documents, or portions of documents, cited herein, including but not limited to patents, patent applications, articles, books, and treatises, are hereby expressly incorporated by reference in their entirety for any purpose. In the event that one or more of the incorporated documents or portions of documents defines a term that contradicts that term's definition in this application, this application controls.

The use of the singular includes the plural unless specifically stated otherwise. The word “a” or “an” means “at least one” unless specifically stated otherwise. The use of “or” means “and/or” unless stated otherwise. The meaning of the phrase “at least one” is equivalent to the meaning of the phrase “one or more.” Furthermore, the use of the term “including,” as well as other forms, such as “includes” and “included,” is not limiting. Also, terms such as “element” or “component” encompass both elements or components comprising one unit and elements or components that comprise more than one unit unless specifically stated otherwise.

### Definitions

The term “operably connected” as used herein means that two or more moieties, which are described as operably connected, are physically connected in such a way that each of the moieties is able to function in the manner for which it is intended. As a nonlimiting example, an inlet port is operably connected to a separation region when the inlet port can be used, e.g., to flow a fluid through the inlet port into the separation region, and the separation region is able to function as intended, e.g., to separate biological particles.

As used herein, the term “biological particle” includes, but is not limited to, eukaryotic cells, prokaryotic cells, and viral particles. Exemplary biological particles include, but are not limited to, sperm cells, epithelial cells, erythrocytes (red blood cells, about 7 μm), leukocytes (neutrophils, about 12-15 μm; eosinophils, about 12-15 μm; basophils, about 12-15 μm; monocytes, about 12-18 μm; lymphocytes, about 5-15 μm), bacterial cells (about 1 μm), and viral particles (a few nanometers).

Exemplary bacterial cells include, but are not limited to, Staphylococcus aureus, Pseudomonas aeniginosa, Enterococcus faecalis, Streptococcus Group B.

Leukocytes can be further subdivided into granular leukocytes, i.e. neutrophils, basophils and eosiniphils, and non-granular leukocytes, i.e. monocytes and lymphocytes. Granular leukocytes are all approximately the same size—about 12-15 μm in diameter. Monocytes can be slightly larger than granulocytes (about 12-18 μm in diameter). Lymphocytes are very variable in size. The smallest may be smaller than erythrocytes (down to ˜5 μm in diameter) while the largest may reach the size of large granulocytes (up to 15 μm in diameter).

In healthy individuals the relative numbers of circulating leukocyte types are quite stable. A differential leukocyte count would typically produce the following cell frequencies

˜60% neutrophils (50%-70%)

˜3% eosinophils (>0%-5%)

˜0.5% basophils (>0%-2%)

˜5% monocytes (1%-9%)

˜30% lymphocytes (20%-40%)

Red blood cells do not contain genomic DNA and the heme groups in the red blood cells can also inhibit a PCR reaction. Microfluidic filtration devices are ideally suited for removing red blood cells from a sample to enable the direct PCR-based genetic analysis of leukocytes by simply passing the blood through microfluidic filtration device.

### Certain Exemplary Apparatuses

Certain Exemplary Pinched Flow Fractionation Apparatuses

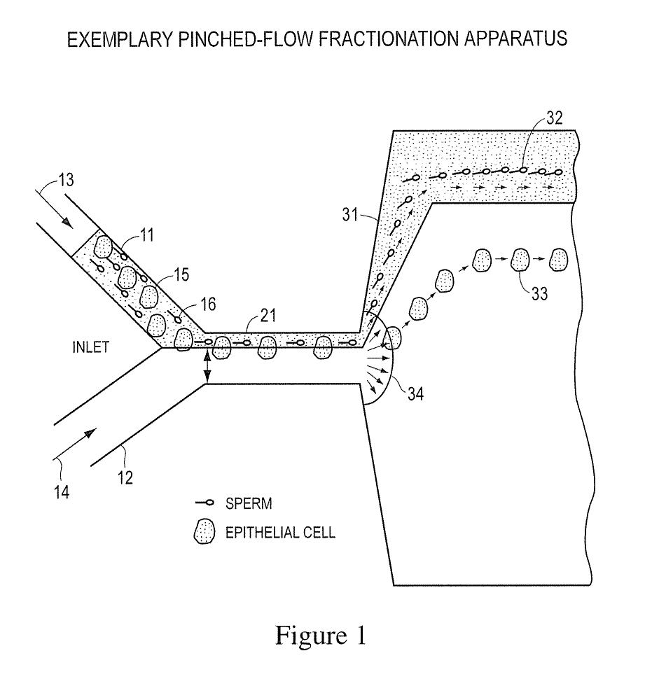

In various embodiments, biological particles can be separated using a pinched flow fractionation apparatus. Exemplary pinched flow fractionation apparatuses are described, e.g., in Yamada et al., Anal. Chem. 76: 5465 (2004). A non-limiting exemplary pinched flow fractionation apparatus 1 is also shown in FIG. 1. That exemplary apparatus comprises two inlet ports 11, 12, a separation region (or “pinched segment”) 21 and a broadened region 31.

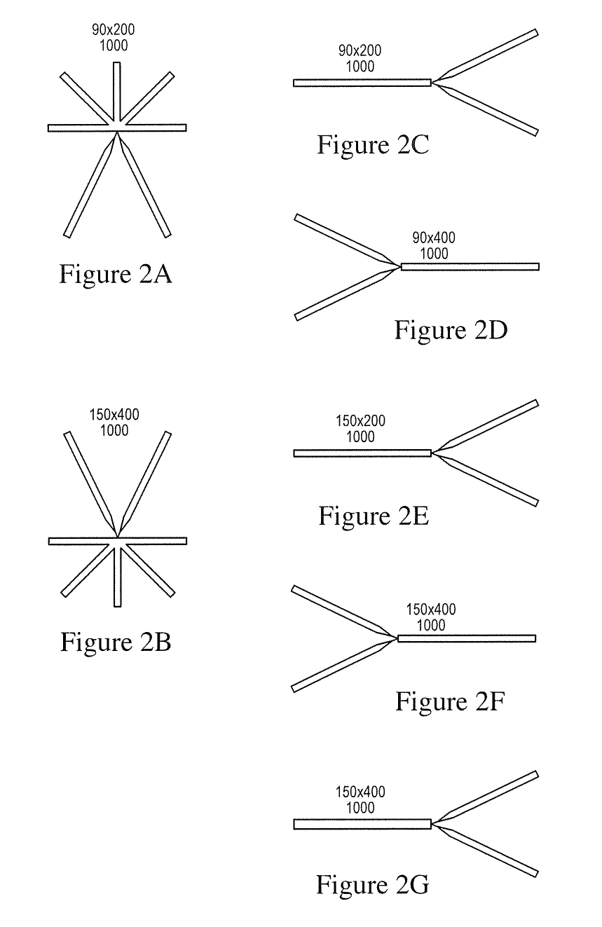

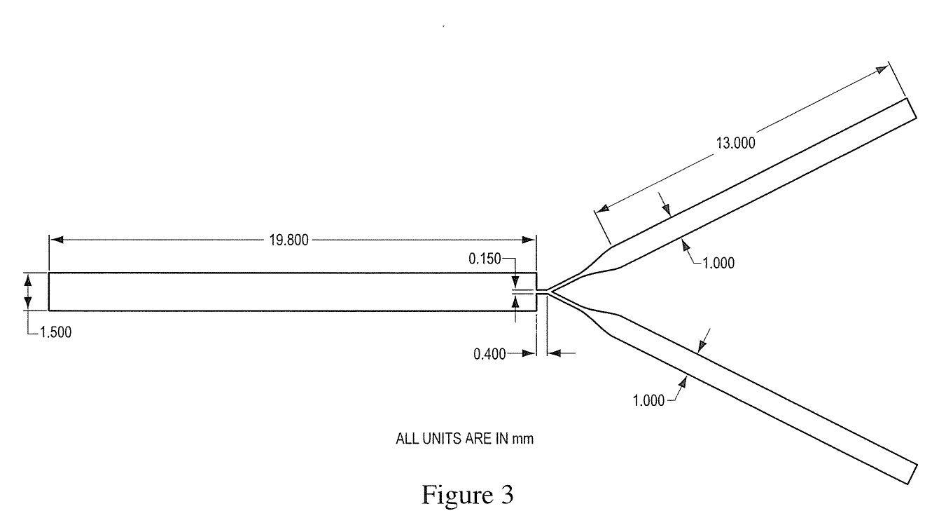

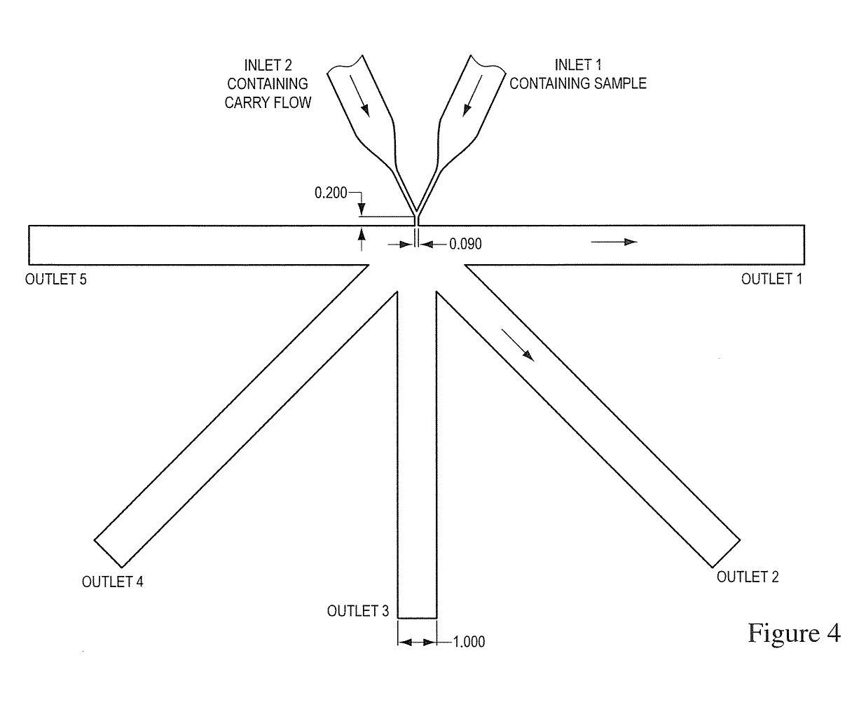

Certain non-limiting exemplary pinched flow fractionation apparatuses are also shown in FIGS. 2A and 2B and FIG. 4. The apparatuses of FIGS. 2A and 2B comprise five collection channels directly connected to the pinch channel. The intersection that immediately connected to the pinch channel is considered a broadened region. FIG. 2A includes a pinch channel with a width of 90 μm and length of 200 μm. The width of the broadened channel of the pinched flow apparatus in FIG. 2A is 1000 μm. The pinched flow apparatus shown in FIG. 2B includes a pinch channel with a width of 150 μm and length of 400 μm. The width of the broadened channel of the pinched flow apparatus in FIG. 2B is 1000 μm. FIG. 3 also includes a pinch channel with a width of 90 μm and length of 200 μm, and a broadened channel of 1000 μm.

Certain non-limiting exemplary pinched flow fractionation apparatuses are also shown in FIGS. 2C to 2G and FIG. 3. The pinched flow apparatus shown in FIG. 2C includes a pinch channel with a width of 90 μm and length of 200 μm. The width of the broadened channel of the pinched flow apparatus in FIG. 2C is 1000 μm. The pinched flow apparatus shown in FIG. 2D includes a pinch channel with a width of 90 μm and length of 400 μm. The width of the broadened channel of the pinched flow apparatus in FIG. 2D is 1000 μm. The pinched flow apparatus shown in FIG. 2E includes a pinch channel with a width of 150 μm and length of 200 μm. The width of the broadened channel of the pinched flow apparatus in FIG. 2E is 1000 μm. The pinched flow apparatus shown in FIG. 2F includes a pinch channel with a width of 150 μm and length of 400 μm. The width of the broadened channel of the pinched flow apparatus in FIG. 2F is 1000 μm. The pinched flow apparatus shown in FIG. 2G includes a pinch channel with a width of 150 μm and length of 400 μm. The width of the broadened channel is 1500 μm. The pinched flow apparatus shown in FIG. 3 also includes a pinch channel with a width of 150 μm and length of 400 μm, and has a broadened channel of 1500 μm.

In various embodiments, a pinched flow apparatus comprises at least two inlet ports, a separation region, and a broadened region. In certain embodiments, a pinched flow apparatus further comprises at least one outlet port. In certain embodiments, a pinched flow apparatus further comprises at least one detecting region. In various embodiments, a detecting region may be within an outlet port, within a broadened region, within a separation region, or within an inlet port. In certain embodiments, a pinched flow fractionation apparatus comprises more than one detecting region. In certain embodiments, a pinched flow fractionation apparatus comprises a first detecting region upstream of the separation region and a second detecting region downstream of the separation region.

One skilled in the art can select the width of the separation region based on the biological particles to be separated. Similarly, one skilled in the art can select the angle of the boundary and the width ratio between the separation region and the broadened region. Certain exemplary selection criteria for the width of the separation region and the angle of the boundary are described, e.g., in Yamada et al., Anal. Chem. 76: 5465 (2004). As a non-limiting example, the width of the separation region is chosen such that it is between about 1.3 and 1.8 times the width of the largest biological particle to be separated in the apparatus. Thus, for example, if the apparatus is to be used to separate sperm cells from epithelial cells, the width of the separation region is chosen such that it is between about 1.3 and 1.8 times the width of an epithelial cell.

The pinched flow fractionation apparatus may be constructed of any material or materials that do not interfere with fluid flow or detrimentally interact with the fluid or the biological particles being separated. Exemplary materials that can be used to construct a pinched flow fractionation apparatus include, but are not limited to, glass, quartz, silicon, and polymeric substrates, e.g., plastics, depending on the intended application.

Certain Exemplary Split-Flow Thin Fractionation Apparatuses

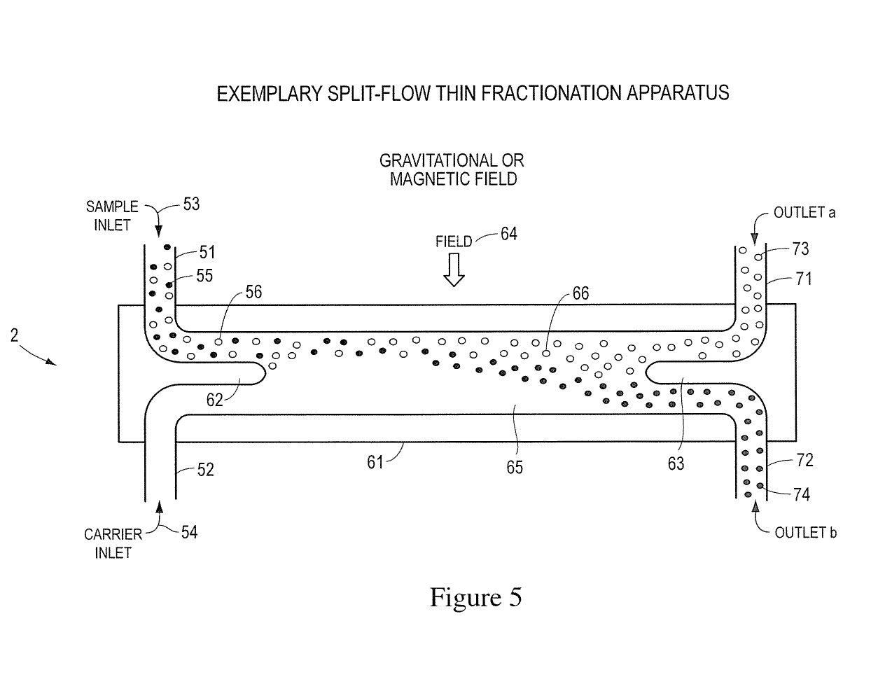

In various embodiments, biological particles can be separated using a split-flow thin fractionation apparatus. Exemplary split-flow thin fractionation apparatuses are described, e.g., in Benincasa et al., Anal. Chem. 77: 5294 (2005); and Fuh et al., Anal. Chem. 72: 266A (2000). A non-limiting exemplary split-flow thin fractionation apparatus 2 is also shown in FIG. 5. That exemplary split-flow thin fractionation apparatus 2 comprises two inlet ports 51, 52, a separation region 61, two boundaries (or “splitters”) 62, 63, two outlet ports 71, 72, and means for applying at least one force (or “field”) in the separation region 64.

In certain embodiments, a split-flow thin apparatus further comprises at least one detecting region. See, for example and not limitation, FIG. 5, which depicts a split-flow thin apparatus that has two possible detecting regions at 71 and 72. In various embodiments, a detecting region may be within an outlet port, within a separation region, or within an inlet port. In certain embodiments, a split-flow thin fractionation apparatus comprises more than one detecting region. In certain embodiments, a split-flow thin fractionation apparatus comprises a first detecting region upstream of the separation region and a second detecting region downstream of the separation region. In certain embodiments, a split-flow thin fractionation apparatus comprises a first detecting region within a first outlet port and a second detecting region within a second outlet port.

In various embodiments, a split-flow thin fractionation apparatus is designed to permit exertion of at least one force on the biological particles within the separation region. Non-limiting exemplary forces include, but are not limited to, gravitational force, centrifugal force, electrical force, and magnetic force. When the split-flow thin fractionation apparatus is designed to permit exertion of an electrical force, for example, the apparatus may comprise one or more electrodes in or near the separation region. When the split-flow thin fractionation apparatus is designed to permit exertion of a magnetic force, for example, the apparatus may comprise one or more magnets in or near the separation region. When the split-flow thin fractionation apparatus is designed to permit exertion of a centrifugal force, for example, the apparatus may be designed such that it can be operated within a centrifugation apparatus. When the split-flow thin fractionation apparatus is designed to permit exertion of a gravitational force, for example, the apparatus may be designed such that sufficient gravitational force is exerted on the biological particles in the separation region to permit separation of at least some of the biological particles from one another. See, e.g., Benincasa et al., Anal Chem. 77: 5294 (2005).

In certain embodiments, a split-flow thin fractionation apparatus comprises one or more boundaries, or “splitters,” within the separation region to facilitate fractionation of the separated biological particles. See, e.g., Benincasa et al., Anal. Chem. 77: 5294 (2005) at FIG. 1. In certain embodiments, rather than splitters, the inlet ports and/or the outlet ports of a split-flow fractionation apparatus are configured such that they form a splitter at the end of the separation region. See, e.g., FIG. 5. Splitters may facilitate smoother merging of the inlet flows and smoother separation of the outlet flows. Such smooth merging and smooth separation reduces fluid turbulence, which may interfere with separation of the biological particles.

The split-flow thin fractionation apparatus may be constructed of any material or materials that do not interfere with fluid flow or detrimentally interact with the fluid or the biological particles being separated. Such materials include, but are not limited to, glass, quartz, silicon, and polymeric substrates, e.g., plastics, depending on the intended application.

Certain Exemplary Asymmetric Laminar Flow Apparatuses

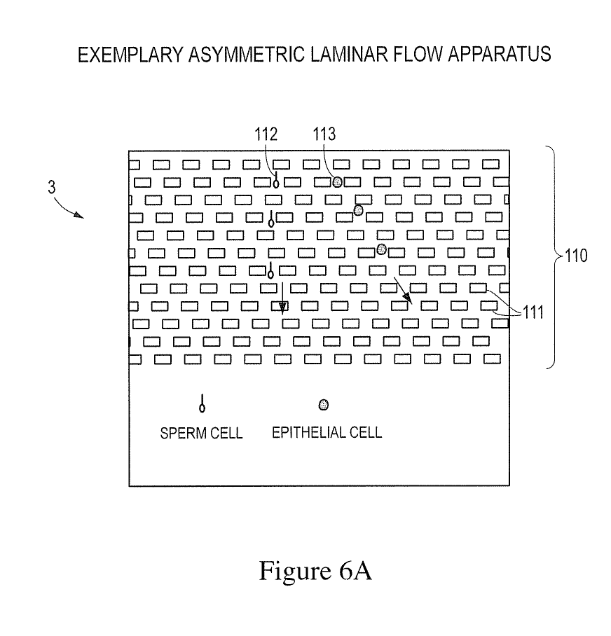

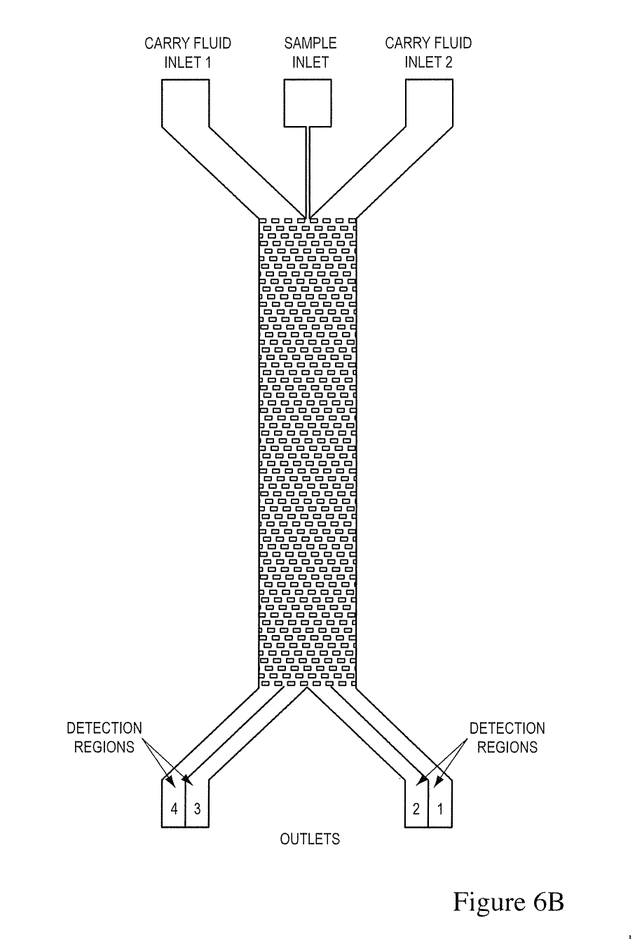

In various embodiments, biological particles can be separated using an asymmetric laminar flow apparatus. Exemplary asymmetric laminar flow apparatuses are described, e.g., in Huang et al., Science 304: 987 (2004). The separation region of a non-limiting exemplary asymmetric laminar flow apparatus 3 is also shown in FIG. 6A. That asymmetric laminar flow apparatus comprises a separation region 110 comprising an array of obstacles 111. An example of an asymmetric laminar flow apparatus comprising inlet ports, outlet ports, and a detection region is shown in FIG. 6B.

In various embodiments, an asymmetric laminar flow apparatus comprises at least one inlet port and a separation region comprising an array of obstacles. In certain embodiments, an asymmetric laminar flow apparatus further comprises at least one outlet port. In certain embodiments, an asymmetric laminar flow apparatus further comprises at least one detecting region. In various embodiments, a detecting region may be within an outlet port, within a separation region, or within an inlet port. In certain embodiments, an asymmetric laminar flow apparatus comprises more than one detecting region. In certain embodiments, an asymmetric laminar flow apparatus comprises a first detecting region upstream of the separation region and a second detecting region downstream of the separation region.

One skilled in the art can select the size of the obstacles in the separation region, as well as the distance between the obstacles, based on the biological particles to be separated. Certain exemplary selection criteria for the size and separation of the obstacles in the separation region are described, e.g., in Huang et al., Science 304: 987 (2004).

As a non-limiting example, in order to separate sperm cells from epithelial cells, each obstacle is about 160 μm long in the dimension perpendicular to fluid flow. The space between obstacles is 80 μm. If the fluid flow is considered to be in the vertical direction, each row of obstacles in the horizontal dimension is shifted by about 40 μm with respect to the previous row of obstacles. As a result, as fluid flows through the space between two obstacles in a first row, it encounters an obstacle in its path in a second row, and must bifurcate to travel around that obstacle. A sperm cell, which is about 5 μm in diameter, will follow a different flow path than an epithelial cell, which is about 60 μm in diameter. See, e.g., FIG. 6A.

In certain embodiments, the distance of lateral shift in each row is greater than the size of a sperm cell but smaller than the size of an epithelial cell. In certain such embodiments, post arrays with lateral shift between 6 μm and 60 μm could be used to separate sperm cells from epithelial cells. In certain such embodiments, the minimum spacing between obstacles should be larger than the size of the epithelial cells and the minimum spacing between each row of posts should equal to the size of epithelial cells.

In various embodiments, one or more outlet ports are operably connected to the separation region such that fluid emerging from different locations of the separation region flows into different outlet ports. One skilled in the art can select appropriate outlet ports according to where certain biological particles will emerge from the separation region.

The asymmetric laminar flow apparatus may be constructed of any material or materials that do not interfere with fluid flow or detrimentally interact with the fluid or the biological particles being separated. Such materials include, but are not limited to, glass, quartz, silicon, and polymeric substrates, e.g., plastics, depending on the intended application.

Certain Exemplary Separation Apparatuses Comprising Posts

In various embodiments, biological particles can be separated using a separation apparatus comprising posts in the separation region. In various embodiments, an apparatus comprises at least one inlet port and at least one a separation region. The separation region comprises, in various embodiments, two or more posts structurally arranged to permit biological particles of a first size to pass from a first location in the separation region to a second location in the separation region, while preventing biological particles of a second size from passing from the first location to the second location. In various embodiments, an apparatus further comprises at least one outlet port.

The separation region may be of any shape that permits fluid to flow from a first end of the separation region to a second end of the separation region. Exemplary separation regions include those that are, for example, rectangular, having four side walls and two ends; and cylindrical. In various embodiments, the separation region is elongated, such that the ends are further apart than the side walls or the diameter of the cylinder. In various embodiments, the separation region comprises a pinched segment. The separation region need not be elongated, however; its ends may be closer together than its walls. One skilled in the art can select an appropriate shape for the separation region, according to the application intended for the apparatus.

In various embodiments, the separation region comprises two or more posts. In various embodiments, where the separation region is cylindrical, each post extends between one side of the cylinder and another side of the cylinder. In various embodiments, where the separation region comprises walls, each post extends from one wall of the separation region to another wall of the separation region. All of the posts need not extend between the same two walls. As a nonlimiting example, in a rectangular apparatus having walls 1, 2, 3, and 4, where walls 1 and 3 are parallel to one another, and walls 2 and 4 are parallel to one another, some posts may extend between walls 1 and 3, while some posts extend between walls 2 and 4. Furthermore, in various embodiments, the posts may extend between walls that are adjacent to one another, or otherwise are not parallel, i.e., in the above example, between walls 1 and 2, walls 2 and 3, walls 3 and 4, and/or walls 4 and 1. Furthermore, in various embodiments, one group of posts may extend between a first set of walls, while a second group of posts may extend between a second set of walls.

In various embodiments, the apparatus comprises at least one row of posts between a first end of the separation region and a second end of the separation region. In various embodiments, the apparatus comprises at least two rows of posts between the first end of the separation region and the second end of the separation region. A “row of posts” as used herein, refers to two or more posts that are aligned along the same plane extending between the first end of the separation region and the second end of the separation region. The plane may or may not be parallel to one or more walls of the separation region. As a non-limiting example, the plane may be close to a first wall at one end of the separation region, and close to a second wall an the other end of the separation region. In certain embodiments, the apparatus comprises more than two, or more than three, or more than five, or more than ten, or more than twenty rows of posts that extend between the first end of the separation region and the second end of the separation region.

In various embodiments, all of the posts are parallel to one another. In various embodiments, a first group of posts comprises posts that are parallel to one another and a second group of posts comprises posts that are parallel to one another, but the first group of posts and the second group of posts are not parallel to one another. A group of posts need not be in a row (i.e., a group of posts is not necessarily a row of posts). In certain embodiments, the first group of posts and the second group of posts are perpendicular to one another. In various embodiments, the first group of posts and the second group of posts are neither parallel nor perpendicular to one another, but are positioned at some other angle with respect to each other. Furthermore, in various embodiments, the apparatus comprises more than two groups of posts, more than three groups of posts, more than five groups of posts, etc., where none of the groups is parallel to another group of posts. One skilled in the art can select an appropriate arrangement of posts in the apparatus, according to the application intended for the apparatus.

The spacing between each pair of adjacent posts may be the same or different throughout the apparatus. In various embodiments, the posts may be arranged such that a first row of posts has a first spacing between adjacent posts, a second row of posts has a second spacing between adjacent posts, a third row of posts has a third spacing between adjacent posts, etc. Furthermore, the spacing between the first and second rows of posts and the spacing between the second and third rows of posts, etc., may be the same or different. In certain embodiments, the spacing between the posts decreases from one row to the next. That is, the first row may allow biological particles of size x to pass between the posts, and the second row may only allow biological particles of size x-y to pass between the posts, and the third row may only allow biological particles of size x-2y to pass between the posts, etc. In that manner, biological particles of different sizes are excluded by different rows of posts in the apparatus.

In various embodiments, the spacing between each pair of adjacent posts in a row may be the same or different. In various embodiments, the posts in a row may be arranged such that the spacing between each successive pair of posts increases or decreases along the row. Alternatively, the spacing between a particular pair of posts in a row may be different from one or more other pairs of posts in a row, although the spacing does not consistently increase or decrease along the row. One skilled in the art can select the appropriate spacing between the posts in the apparatus, according to the desired application for the apparatus.

The posts in the apparatus may be of any shape or size, so long as they function in the intended manner. As non-limiting examples, the cross-section of each post may be circular, elliptical, rectangular, square, hexagonal, triangular, etc. In various embodiments, the posts are elongated, for example, elliptical or rectangular. In various embodiments, the posts may be in any rotational orientation along the long axis of the posts. For example, in certain embodiments, when an apparatus comprises a single row of elliptical posts, while the row of posts extends along a single plane from one end of the separation region to the other end of the separation region, each individual post may be rotated so that the ends of the ellipse are out of that plane. That is, while the long axis running through the center of each post lies in the same plane, the axis extending from one end of the elliptical cross-section (“cross-sectional axis”) of each post to the other need not lie in that plane. In certain embodiments, the cross-sectional axes of the posts in the row or group are parallel to one another. One skilled in the art can select appropriately shaped and sized posts, as well as appropriate rotational orientations, according to the intended application for the apparatus.

An apparatus comprises at least one inlet port, according to various embodiments, that is operably connected to a first end of the separation region, such that a fluid can pass from the inlet port into the separation region. In various embodiments, the apparatus may comprise one, two, three, four, or more than four inlet ports. In certain embodiments, all of the inlet ports are operably connected to the same end of the separation region. In certain embodiments, one or more inlet ports are operably connected an end of the separation region, while one or more additional inlet ports are operably connected to the separation region at a location other than an end. For example, in certain such embodiments, the posts near a first end of the separation region may be positioned to permit particles of size A to pass from a first location in the separation to a second location in the separation region, and the posts near the second end of the separation region may be positioned to permit particles of larger size B to pass from a first location in the separation to a second location in the separation region. In that apparatus, in certain embodiments, a first outlet port may be positioned near the first end of the separation region to permit particles of size A to flow through the first outlet port, and a second outlet port may be positioned near the second end of the separation region to permit particles of size B to flow through the second outlet port. In certain embodiments, very few or no particles of size B flow through the first outlet port in that apparatus.

In certain embodiments, an apparatus comprises one or more inlet ports operably connected to the separation region at a location other than an end.

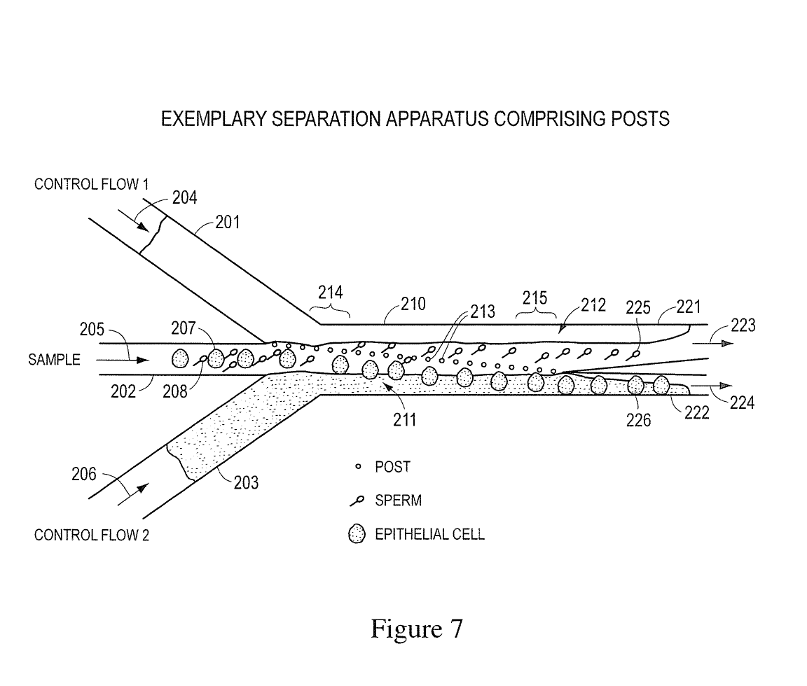

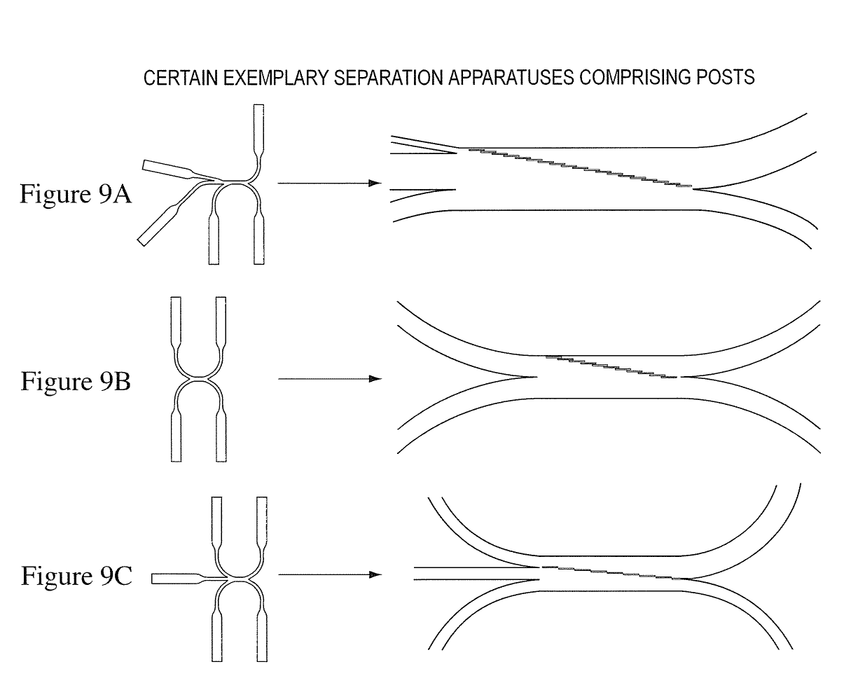

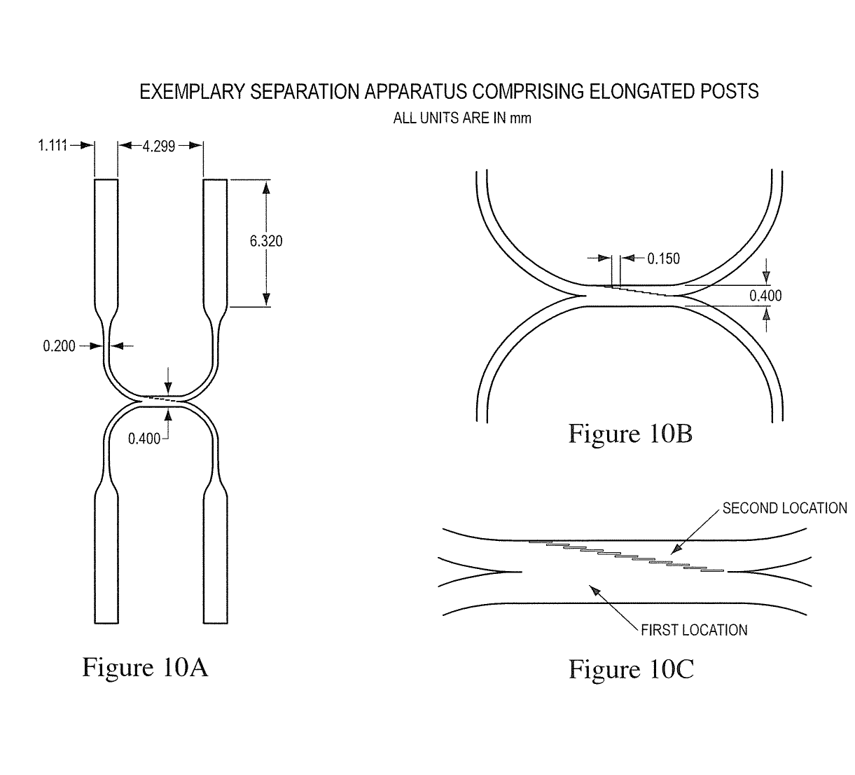

In various embodiments, an apparatus comprises one inlet port for flowing a sample containing biological particles to be separated into the separation region, and one or more separate inlet ports for flowing one or more fluids that do not contain biological particles to be separated into the separation region. In certain embodiments, the apparatus comprises three inlet ports: the first inlet port is used to flow the sample containing biological particles to be separated into the separation region, and the second and third inlet ports are used to flow one or more fluids that do not contain biological particles to be separated into the separation region. See, e.g., FIGS. 7, 8, 9C, 9B, and 11. In certain embodiments, the apparatus comprises two inlet ports: the first inlet port is used to flow the sample containing biological particles to be separated into the separation region, and the second inlet port is used to flow one or more fluids that do not contain biological particles to be separated into the separation region. See, e.g., FIGS. 9B and 10.

In certain embodiments, the inlet port used to flow the sample containing biological particles to be separated into the separation region is also used to flow one or more fluids that do not contain biological particles to be separated into the separation region. In certain embodiments, the apparatus comprises two inlet ports; a first inlet port is used to flow the sample containing biological particles to be separated into the separation region, and that same inlet port is also used to flow one or more fluids that do not contain biological particles to be separated into the separation region, and a second inlet port that is also used to flow one or more fluids that do not contain biological particles to be separated into the separation region.

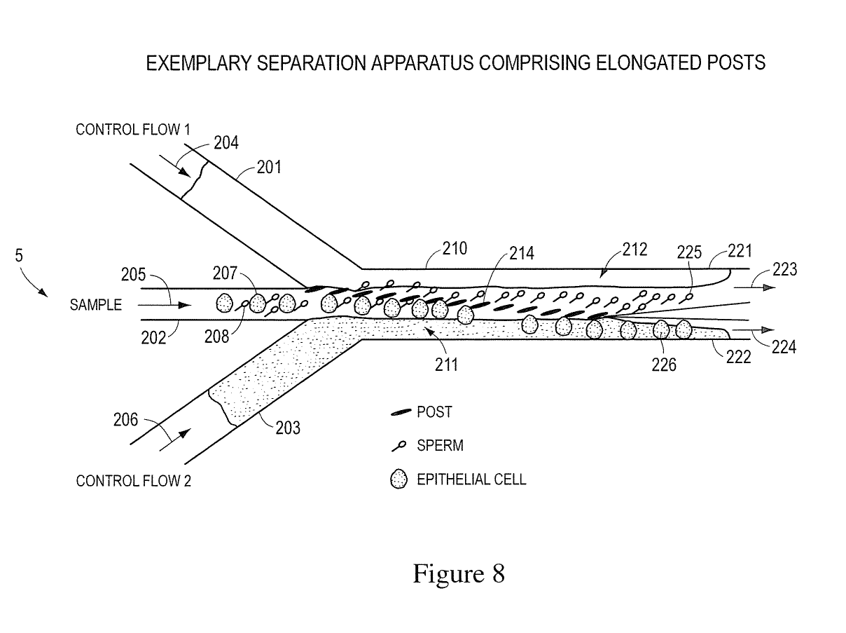

In various embodiments, two of the inlet ports of the apparatus are arranged such that a fluid flowing through the first inlet port enters the separation region on one side of at least one row or group of posts, and a fluid flowing through the second inlet port enters the separation region on the other side of the at least one row or group of posts. See, e.g., FIGS. 7 and 8.

In various embodiments, an apparatus comprises at least one outlet port that is operably connected to a second end of the separation region. In various embodiments, an apparatus comprises at least one outlet port that is operably connected to the separation region at a location other than an end. An apparatus may comprise, in various embodiments, one or more outlet ports operably connected to an end of the separation region, and one or more outlet ports operably connected to the separation region at a location other than an end.

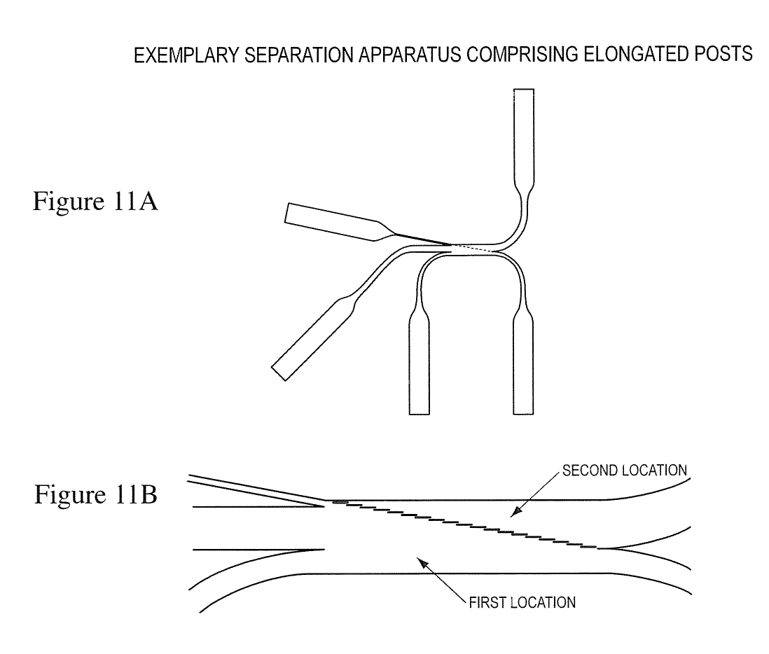

In various embodiments, two of the outlet ports of the apparatus are arranged such that a fluid flowing from the separation region on one side of at least one row or group of posts flows into a first outlet port, and a fluid flowing from the separation region on the other side of at least one row or group of posts flows into a second outlet port. In certain such embodiments, biological particles that are able to pass between the posts to a second location in the separation region flow into a first outlet port, while biological particles that remain in the first location in the separation region flow into a second outlet port. See, e.g., FIGS. 10 and 11.

In certain embodiments, an apparatus further comprises a detecting region. In various embodiments, a detecting region may be within an outlet port, within a separation region, or within an inlet port. In certain embodiments, an apparatus comprises more than one detecting region. In certain embodiments, an apparatus comprises a first detecting region upstream of the separation region and a second detecting region downstream of the separation region.

The apparatus may be constructed of any material or materials that do not interfere with fluid flow or detrimentally interact with the fluid or the biological particles being separated. Such materials include, but are not limited to, glass, quartz, silicon, and polymeric substrates, e.g., plastics, depending on the intended application.

Certain exemplary apparatuses comprising posts are shown in FIGS. 7 to 12. FIG. 7 shows an exemplary apparatus 4 comprising three inlet ports 201, 202, 203, a separation region 210 comprising a row of posts 213 that separate a first location 211 in the separating region from a second location 212 in the separating region, and two outlet ports 221, 222. FIG. 8 shows an apparatus 5 that is similar to the apparatus of FIG. 7, except the posts in the row of posts 214 are elongated.

FIG. 9A shows an exemplary apparatus comprising three inlet ports and two outlet ports. A row of posts in the separating region separates the two outlet ports, as is shown in the enlarged image of a portion of the apparatus of FIG. 9A. FIG. 9B shows an exemplary apparatus comprising two inlet ports and two outlet ports. A row of posts in the separating region separates the two outlet ports, as is shown in the enlarged image of a portion of the apparatus of FIG. 9B. FIG. 9C shows an exemplary apparatus comprising three inlet ports and two outlet ports. A row of posts in the separating region separates the two outlet ports, as is shown in the enlarged image of a portion of the apparatus of FIG. 9C.

FIG. 10 shows an exemplary apparatus comprising two inlet ports and two outlet ports. A row of posts in the separating region separates the two outlet ports, as is shown in FIGS. 10B and 10C, which show enlarged images of portions of the apparatus. As shown in FIG. 10B, the width of the channel in the separating region is 0.400 mm, and each post is 0.150 mm in length. The arrangement of posts in the separating region causes particles passing through the separation region to be directed to either a first location or a second location based on the size of the particle.

FIG. 11 shows an exemplary apparatus comprising three inlet ports and two outlet ports. A row of posts in the separating region separates the two outlet ports, as is shown in the enlarged image of a portion of the apparatus of FIG. 11. A row of posts in the separating region separates the two outlet ports, as is shown in FIG. 11B, which show enlarged images of portions of the apparatus. The arrangement of posts in the separating region causes particles passing through the separation region to be directed to either a first location or a second location based on the size of the particle.

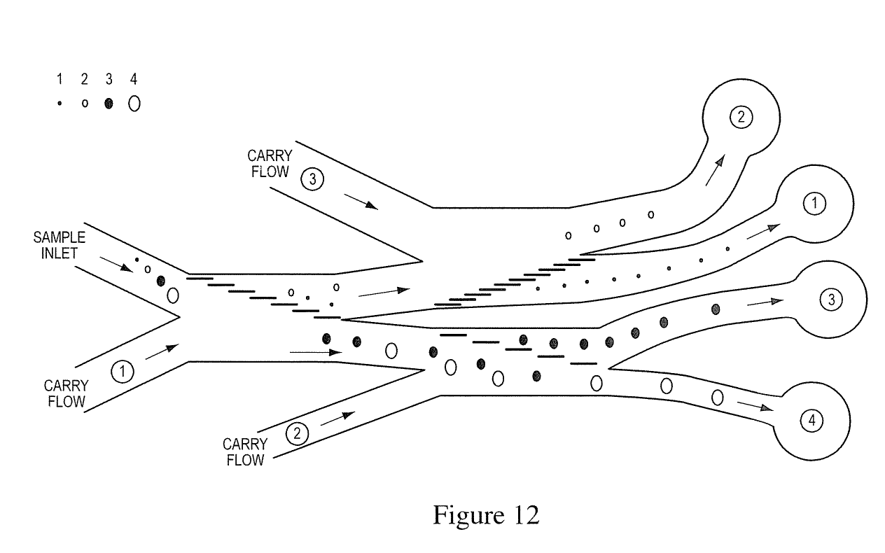

FIG. 12 shows an exemplary apparatus comprising three inlet ports, four outlet ports, and three separating regions. The separating regions in the apparatus are arranged in a serial orientation, so that any particle passing through the apparatus encounters two separating regions. The serial orientation of the three separating regions causes particles passing through the separation region to be directed to one of the four different outlet ports of the apparatus.

### Certain Exemplary Methods

In various embodiments, methods of separating two or more biological particles are provided. In various embodiments, methods of separation sperm cells and epithelial cells are provided. In various embodiments, methods of separating blood cells are provided.

Certain Exemplary Methods Using Pinched Flow Fractionation Apparatuses

In certain embodiments, two or more biological particles are separated using a pinched flow fractionation apparatus. In certain embodiments, sperm cells and epithelial cells are separated using a pinched flow fractionation apparatus. Certain exemplary methods of separating particles using such apparatuses are described, e.g., in Yamada et al., Anal. Chem., 76: 5465 (2004).

A non-limiting exemplary method of separating two or more biological particles using a pinched flow fractionation apparatus as shown in FIG. 1, comprising two inlet ports, a separation region, and a broadened region, is as follows. A first liquid 13 comprising two or more biological particles to be separated 15, 16 is flowed through a first inlet port 11 into the separation region 21. A second liquid 14 that does not comprise any biological particles to be separated is flowed through a second inlet port 12 into the separation region 21.

In certain embodiments, after the first liquid comprising two or more biological particles to be separated has been flowed into the first inlet port, a second liquid that does not comprise any biological particles to be separated is flowed into the second inlet port. In various embodiments, the first liquid and the second liquid are continuously flowed during separation of the biological particles, although the flow rate of one or both of the liquids may be increased or decreased during separation. The flow rates of the first liquid and the second liquid are adjusted such that the biological particles to be separated are aligned along one wall of the separation region. See, e.g., Yamada et al., Anal. Chem. 76: 5465 (2004). At the boundary between the separation region and the broadened region, the fluid flow fans out (34) such that different forces are exerted at different locations at the boundary. Larger biological particles experience a greater portion of the locations at the boundary than smaller biological particles, which experience a smaller portion of the locations at the boundary. As a result, the trajectory of larger biological particles 33 as they enter the broadened region is different from the trajectory of smaller biological particles 32 as they enter the broadened region. See, e.g., Yamada et al., Anal. Chem. 76: 5465 (2004), and FIG. 1. The larger and smaller biological particles therefore become separated in the broadened region of the apparatus.

In certain embodiments, the apparatus comprises one or more outlet ports such that one or more biological particles enter an outlet port after passing through the broadened region of the apparatus. In certain embodiments, the apparatus comprises one outlet port into which a first biological particle flows, and a second outlet port into which a second biological particle flows. In certain embodiments, the second outlet port is configured such that greater than half of the liquid from the broadened region flows into the second outlet port. In certain embodiments, the second outlet port is connected to a waste collection device.

In various embodiments, the biological particles to be separated are detected at one or more locations in the apparatus. For example, the biological particles may be detected before and/or after separation, e.g., to determine the efficiency of separation.

Certain Exemplary Methods Using Split-Flow Thin Fractionation Apparatuses

In certain embodiments, two or more biological particles are separated using a split-flow thin fractionation apparatus. In certain embodiments, sperm cells and epithelial cells are separated using a split-flow thin fractionation apparatus. Certain exemplary methods of separating particles using such apparatuses are described, e.g., in Benincasa et al., Anal. Chem. 77: 5294 (2005); and Fuh et al., Anal. Chem. 72: 266A (2000). See also FIG. 5.

A non-limiting exemplary method of separating two or more biological particles using a split-flow fractionation apparatus 2 as shown in FIG. 5, comprising two inlet ports 51, 52, a separation region 61, means for applying a force (or “field”) 64, and two outlet ports 71, 72, is as follows. Microparticles are selectively attached to first biological particles 55, which are to be separated from second biological particles 56. Exemplary microparticles include, but are not limited to, paramagnetic particles and particles that alter the density of the biological particle. In certain embodiments, microparticles are attached to more than one type of biological particles. In certain embodiments, a first type of microparticle is attached to a first type of biological particle, and a second type of microparticle is attached to a second type of biological particle, etc. Appropriate microparticles can be selected by one skilled in the art, according to the biological particles to be separated and the force to be exerted in the separation region.

In certain embodiments, a first liquid 53 comprising the first and second biological particles 55, 56 is flowed through the first inlet port 51 into the separation region 61. A second liquid 54 that does not comprise any biological particles to be separated is flowed though the second inlet port 52 into the separation region 61. In certain embodiments, after the first liquid comprising two or more biological particles to be separated has been flowed into the first inlet port, a second liquid that does not comprise any biological particles to be separated is flowed into the second inlet port. In various embodiments, the first liquid and the second liquid are continuously flowed during separation of the biological particles, although the flow rate of one or both of the liquids may be increased or decreased during separation.

In various embodiment, a force 64 is exerted on the biological particles in the separation region 61. As a non-limiting example, if the microparticles attached to the first biological particles are paramagnetic, a magnetic force may be exerted in the separation region. In certain such embodiments, the magnetic force may cause the biological particles and attached microparticles to move to a second location 65 in the separation region 61. The force exerted by the flow cause biological particles not attached to microparticles to move to, or remain in, a first location 66 in the separation region 61. As a result, the biological particles attached to the microparticles are separated from other biological particles in the separation region.

As a second non-limiting example, if the microparticies attached to the first biological particles alter the density of the first biological particles, e.g., by increasing the density of those particles, a gravitational force may be exerted in the separation region. In certain such embodiments, the gravitational force may cause the biological particles and attached microparticles to move to a second location in the separation region. The force exerted by the flow may cause biological particles not attached to microparticles to move to, ore remain in, a first location in the separation region. As a result, the biological particles attached to the microparticles are separated from other biological particles in the separation region.

In certain embodiments, the apparatus comprises one or more outlet ports 71, 72 such that one or more biological particles enter an outlet port after passing through the broadened region of the apparatus. In certain embodiments, two or more outlet ports may be located such that fluid and biological particles in a first location in the separation region flow into a first outlet port 71, while fluid and biological particles in a second location in the separation region flow into a second outlet port 72, etc. In certain embodiments, the apparatus comprises one outlet port 71 into which a first biological particle 73 flows, and a second outlet port 72 into which a second biological particle 74 flows. In certain embodiments, an outlet port is configured such that greater than half of the liquid from the broadened region flows into the outlet port. In certain embodiments, an outlet port is connected to a waste collection device.

In various embodiments, the biological particles to be separated are detected at one or more locations in the apparatus. For example, the biological particles may be detected before and/or after separation, e.g., to determine the efficiency of separation.

Certain Exemplary Methods Using Asymmetric Laminar Flow Apparatuses

In certain embodiments, two or more biological particles are separated using an asymmetric laminar flow apparatus. In certain embodiments, sperm cells and epithelial cells are separated using an asymmetric laminar flow apparatus. Certain exemplary methods of separating particles using such apparatuses are described, e.g., in Huang et al., Science 304: 987 (2004).

A non-limiting exemplary method of separating two or more biological particles using an asymmetric laminar flow apparatus 3 as shown in FIG. 6A, comprising an inlet port, a separation region 110 comprising an array of obstacles 111, and two outlet ports, is as follows. A first liquid comprising two or more biological particles to be separated is flowed through the inlet port into the separation region 110. A second liquid that does not comprise any biological particles to be separated is then flowed through the inlet port in order to maintain the flow of biological particles through the separation region.

As the biological particles enter the separation region 110, which comprises an array of obstacles 111, larger particles 113 follow a different flow path than smaller particles 112. As a result, in various embodiments, at the end of the separation region, the biological particles are separated according to size. In certain embodiments, two or more outlet ports are operably connected to the end of the separation region such that particles of a first size flow into a first outlet port and particles of a second size flow into a second outlet port. In certain embodiments, the second outlet port is configured such that greater than half of the liquid from the broadened region flows into the second outlet port. In certain embodiments, the second outlet port is connected to a waste collection device.

In various embodiments, the biological particles to be separated are detected at one or more locations in the apparatus. For example, the biological particles may be detected before and/or after separation, e.g., to determine the efficiency of separation.

Certain Exemplary Methods Using Separation Apparatuses Comprising Posts

In certain embodiments, two or more biological particles are separated using a separation apparatus comprising posts. In certain embodiments, sperm cells and epithelial cells are separated using a separation apparatus comprising posts. A non-limiting exemplary method of separating biological particles using an apparatus 4 as shown in FIG. 7, comprising three inlet ports, a separation region comprising two or more posts, and two outlet ports is as follows. The two or more posts are configured such that a first biological particle 208 can pass between the posts 213 to a second location 212 in the separation region 210, while a second biological particle 207 cannot pass between the posts 213 and is therefore confined to a first location 211 in the separation region 210. The apparatus 5 of FIG. 8 functions in a similar manner.

A first liquid 205 comprising first and second biological particles 207, 208 is flowed through a first inlet port 202 into the separation region 210. A second liquid 204 that does not comprise any biological particles to be separated is flowed through a second inlet port 201 into the separation region 210. In the apparatuses 4, 5 shown in FIGS. 7 and 8, a third liquid 206 that does not comprise any biological particles to be separated is flowed through a third inlet port 203 into the separation region 210.

In certain embodiments, the first inlet port 202 is operably connected to the separation region 210 such that the first liquid 205 flows into a first location 211 of the separation region 210 and the second inlet port 201 is operably connected the separation region 210 such that the second liquid 204 flows into a second location 212 of the separation region 210. The first and second biological particles 207, 208 therefore enter the separation region 210 at a first location 211 in the separation region. The first location 211 in the separation region extends from the first end of the separation region 214, where the inlet ports are operably connected, to a second end of the separation region 215, where the outlet ports are operably connected. Thus, a biological particle remaining only in the first location 211 of the separation region may travel from an inlet port 202 to an outlet port 222.

In certain embodiments, after the first liquid comprising two or more biological particles to be separated has been flowed into the first inlet port, a third liquid that does not comprise any biological particles to be separated is flowed into the first inlet port. In various embodiments, the second liquid and the third liquid are continuously flowed during separation of the biological particles, although the flow rate of one or both of the liquids may be increased or decreased during separation.

In various embodiments, the fluid flow is continued such that the force of the flow causes the particles to travel toward the posts in the separation region. In various embodiments, however, the force of the fluid flow is in a direction such that the particles that cannot pass between the posts are not all trapped against the posts or in the spaces between the posts, but are deflected off of the posts and continue to travel through the first location of the separation region toward an outlet port. As a non-limiting example, where the posts in the separation region are in a row, the fluid force is at an angle of less than 90° relative to the plan comprising the row of posts.

In certain embodiments, in order to reduce clogging of the spaces between the posts by biological particles that are too large to pass through the spaces, the first and second fluid flows are adjusted or alternated to create some backflow from the second location of the separation region to the first location of the separation region in order to dislodge some or all of the biological particles clogging the spaces between the posts. After the biological particles have been dislodged, the fluid flows can be readjusted such that the force of the flow again causes particles to flow toward the posts. In various embodiments, the dislodging process is be repeated several times during the separation process.

In various embodiments, the apparatus comprises one or more outlet ports such that one or more biological particles enter an outlet port after passing through the broadened region of the apparatus. In certain embodiments, the apparatus comprises a first outlet port operably connected such that fluid flowing from the first location of the separation region flows into the first outlet port, and a second outlet port operably connected such that fluid flowing from the second location of the separation region flows into the second outlet port. Thus, in certain embodiments, biological particles that are able to pass between the posts in the separation region flow into the second outlet port, while biological particles that are not able to pass between the posts in the separation region flow into the first outlet port. In certain embodiments, the first outlet port is connected to a waste collection device.

In various embodiments, the biological particles to be separated are detected at one or more locations in the apparatus. For example, the biological particles may be detected before and/or after separation, e.g., to determine the efficiency of separation.

### CERTAIN EXAMPLES OF SEPARATING AND DETECTING BIOLOGICAL PARTICLES

### Example 1

A liquid sample containing sperm cells and epithelial cells in a carrier fluid is introduced into a cell separation device. Sperm cells and epithelial cells are separated and transported to separate outlet ports. The separated sperm cells and epithelial cells are removed from the cell separation device and lysed. The sperm DNA and epithelial DNA are purified and used as template DNAs in separate PCR reactions.

### Example 2

A liquid sample containing sperm cells and epithelial cells in a carrier fluid is introduced into a cell separation device. Sperm cells and epithelial cells are separated and transported to separate outlet ports. The separated sperm cells and epithelial cells are lysed in the outlet reservoirs of the cell lysis device. The released DNA is recovered for purification and then used as a template in a PCR reaction.

### Example 3

Blood and a PCR compatible carrier fluid are introduced into a microfluidic filtration device. The red blood cells are about 7 μm in size. Granular leukocytes (neutrophils, eosinophils, and basophils) are about 12-15 μm in size and represent about 65% of the leukocytes. The red blood cells are separated from the granular leukocytes by the microfluidic filtration device. The red blood cells are transported to a first outlet port and the granular leukocytes are transported to a second outlet port. The granular leukocytes in the PCR compatible carry fluid are directly transferred into PCR microwell. The granular leukocytes are lysed and the released DNA is used as a template in a PCR reaction.

### Example 4

A liquid sample containing eukaryotic cells and bacterial cells in a carrier fluid is introduced into a cell separation device. Eukaryotic cells and bacterial cells are separated and transported to separate outlet ports. The separated eukaryotic cells and bacterial cells are removed from the cell separation device and lysed. The eukaryotic DNA and bacterial DNA are purified and used as template DNAs in separate PCR reactions.

### Example 5

A liquid sample containing cells and viral particles in a carrier fluid is introduced into a cell separation device. The cells and viral particles are separated and transported to separate outlet ports. The separated cells and viral particles are removed from the cell separation device and lysed. The cell and viral DNA are purified and used as template DNAs in separate PCR reactions.

1. A method of separating first biological particles from second biological particles, comprising:
a) providing a mixture comprising one or more first biological particles and one or more second biological particles;
b) flowing at least a portion of the mixture and a first liquid into a first inlet port of a separation apparatus, wherein the separation apparatus comprises the first inlet port, a second inlet port, and a separation region, wherein the first inlet port and the second inlet port are operably connected to a first end of the separation region, and wherein the separation region comprises two or more posts aligned along a plane extending along a diagonal axis from the first end of The separation region to a second end of the separation region, wherein The spacing between adjacent posts is such that a first biological particle can pass between The posts but a second biological particle cannot pass between the posts;
c) flowing a second liquid into The second inlet port, wherein The flow rate of the first liquid and the flow rate of the second liquid are such that when the mixture enters the separation region, substantially all of the one or more first biological particles pass between the two or more posts to a second lateral side of The separation region, and substantially all of the one or more second biological particles remain on a first lateral side of the separation region.

2. The method of claim 1, wherein the separation apparatus further comprises a detection region at a second end of the separation region.

3. (canceled)

4. The method of claim 1, wherein The separation apparatus further comprises a first outlet port and a second outlet port operably connected to a second end of the separation region.

5.-8. (canceled)

9. The method of claim 1, wherein the second liquid does not comprise first biological particles or second biological particles.

10. The method of claim 1, wherein the two or more posts are elongated and arranged such that at least one end of each post overlaps with an end of another post and the spacing between the ends of adjacent posts is such that a first biological particle can pass between the ends.

11.-19. (canceled)

20. The method of claim 11, wherein the second liquid and the third liquid do not comprise first biological particles or second biological particles.

21. The method of claim 11, wherein the two or more posts are elongated and arranged such that at least one end of each post overlaps with an end of another post and the spacing between the ends of adjacent posts is such that a first biological particle can pass between the ends.

22. A method of separating first biological particles from second biological particles, comprising:
a) providing a mixture comprising one or more first biological particles and one or more second biological particles;
b) flowing at least a portion of the mixture and a first liquid into a first inlet port of a separation apparatus, wherein the separation apparatus comprises the first inlet port, a second inlet port, and a separation region, wherein the first inlet port and the second inlet port are operably connected to a first end of the separation region, and wherein the separation region comprises two or more posts that are structurally arranged to permit the one or more first biological particles to move to a first location in the separation region while preventing the one or more second biological particles from moving to the first location of the separation region;
c) flowing a second liquid into the second inlet port, wherein the flow rate of the first liquid and the flow rate of the second liquid are such that when the mixture enters the separation region, substantially all of the one or more first biological particles move to the first location in the separation region.

23. The method of claim 22, wherein the separation apparatus further comprises a detection region at a second end of the separation region.

24.-25. (canceled)

26. The method of claim 22, wherein the separation apparatus further comprises a first outlet port and a second outlet port operably connected to a second end of the separation region.

27.-30. (canceled)

31. The method of claim 22, wherein the second liquid does not comprise first biological particles or second biological particles.

32. The method of claim 22, wherein the second biological particles move to a second location in the separation region.

33.-35. (canceled)

36. An apparatus for separating first biological particles from second biological particles, comprising:
a) a separation region;
b) a first inlet port operably connected to a first end of the separation region;
c) a second inlet port operably connected to the first end of the separation region;
d) two or more posts structurally arranged to permit a first biological particle to move to a first location in the separation region while preventing a second biological particle from moving to the first location of the separation region.

37. The apparatus of claim 36, further comprising a detection region at a second end of the separation region.

38.-39. (canceled)

40. The apparatus of claim 36, further comprising a first outlet port and a second outlet port operably connected to a second end of the separation region.

41.-47. (canceled)

48. A method of separating sperm cells from epithelial cells, comprising:
a) providing a mixture comprising one or more sperm cells and one or more epithelial cells;
b) flowing at least a portion of the mixture and a first liquid into a first inlet port of a separation apparatus, wherein the separation apparatus comprises the first inlet port, a second inlet port, a pinched region, and a broadened region, wherein the first inlet port and the second inlet port are operably connected to a first end of the pinched region, and wherein a second end of the pinched region is operably connected to a first end of the broadened region;
c) flowing a second liquid into the second inlet port, wherein the flow rate of the first liquid and the flow rate of the second liquid are such that when the mixture enters the pinched region, substantially all of the cells become aligned against a first wall of the pinched region;
d) continuing to flow the first liquid and the second liquid such that when the mixture enters and passes through the broadened region, the one or more sperm cells and the one or more epithelial cells become separated.

49. The method of claim 48, wherein the separation apparatus further comprises a detection region within the broadened region.

50. (canceled)

51. The method of claim 48, wherein the separation apparatus further comprises a first outlet port and a second outlet port operably connected to a second end of the broadened region.

52.-66. (canceled)

67. A method of separating blood cells, comprising:
a) providing a mixture comprising one or more first blood cells and one or more second blood cells;
b) flowing at least a portion of the mixture and a first liquid into a first inlet port of a separation apparatus, wherein the separation apparatus comprises the first inlet port, a second inlet port, a pinched region, and a broadened region, wherein the first inlet port and the second inlet port are operably connected to a first end of the pinched region, and wherein a second end of the pinched region is operably connected to a first end of the broadened region;
c) flowing a second liquid into the second inlet port, wherein the flow rate of the first liquid and the flow rate of the second liquid are such tat when the mixture enters the pinched region, substantially all of the blood cells become aligned against a first wall of the pinched region;
d) continuing to flow the first liquid and the second liquid such that when the mixture enters and passes through the broadened region, the one or more first blood cells and the one or more second blood cells become separated.

68. The method of claim 67, wherein the separation apparatus further comprises a detection region within the broadened region.

69. (canceled)

70. The method of claim 67, wherein the separation apparatus further comprises a first outlet port and a second outlet port operably connected to a second end of the broadened region.

71.-74. (canceled)

75. The method of claim 67, wherein the second liquid does not comprise first blood cells or second blood cells.

76.-85. (canceled)
